(19) United States
(12) Patent Application Publication
(10) Pub. No.: US 2006/0102407 A1
(43) Pub. Date: May 18, 2006

(54) Log skidder

(76) Inventor: Raynald Berthiaume, St-Gerard-des-Laurentides (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/243,781

(22) Filed: Oct. 6, 2005

Related U.S. Application Data
(63) Continuation of application No. 60/622,847, filed on Oct. 29, 2004.

(51) Int. Cl. B60K 17/34

(52) U.S. Cl. 180/233

(57) ABSTRACT

A forestry vehicular machine includes a front section supported by two front wheels; a rear section articulately connected to the front section, and an engine. The rear section has a frame supported on the ground by a tandem bogey with revolving support members and an arch assembly mounted to the frame. The engine is operatively connected to the front wheels and the revolving support members, the front wheels being imparted a front ground speed and the revolving support members being imparted a rear ground speed, when actuated by the engine, the ratio between the front and the rear ground speeds being greater than 1.

### CROSS-REFERENCE TO RELATED APPLICATIONS

This application is related to U.S. patent application Ser. No. X,XXX,XXX filed on Oct. 5, 2005 and claims priority of U.S. provisional patent application 60/622,847 filed on Oct. 29, 2004, the specification of which is hereby incorporated by reference.

### BACKGROUND OF THE INVENTION

1) Field of the Invention

The invention relates to timber harvesting machines and, more particularly, to log skidders.

2) Description of the Prior Art

Skidders or skidder machines are large articulated heavy duty vehicles for pulling, lugging, dragging, lifting or otherwise removing down timber from the woods. Skidders are characterized by their large size, heavy weight, large tractor tires, and maneuverability. A front section supported by front wheels includes the engine and the operator's cab. A rear section supported by rear wheels is connected to the front section on a vertical axis pivot so as to be articulatable relative to the front section. A hydraulically controlled boom or arch extending rearwardly from the rear section of the skidder machine grasps a tree or a bunch of trees at a lower end with a grapple or cable loop. The boom or the arch is actuated to raise that end of the bundled trees, for example, off the ground and hold them suspended in the air behind the rear wheels of the skidder machine while the machine drags or “skids” the trees out of the forest to waiting transport. Skidders are considered versatile and cost-effective vehicles.

A disadvantage of the conventional skidders is the large size and heavy weight, for example typically ten tons for even the lighter weight skidders. Moreover, the weight of the lifted trees at their lower ends and the counter-weight effect of the machines front end cause the rear wheels to rut and shear soil as they exert traction. The heavy weight, large size, and large tractor tires result in substantial disruption of and damage to the forest floor, soil and undergrowth. The traditional skidders are notorious for the soil erosion problems and disruption resulting from skidder operations.

To reduce damage to the forest floor, skidders having a tandem bogey in the rear section have been developed (See for instance U.S. Pat. No. 6,257,818). The skidders with tandem bogey in the rear section have been developed based on the technology used for transporters. However, transporters and skidders do not operate in the same conditions and do not perform the same task. Therefore, several problems occur with these skidders during operation such as arch assembly breakage, tandem bogey breakage, troubles transporting trees on hills, etc.

After few hours of operation, the arch assembly of log skidders having a tandem bogey in the rear section often breaks. This occurs because the weight of the logs carried by the skidder is mispositioned relatively to the rear section. Breakage often occurs also in the fasteners securing the tandem bogey to the rear frame of the skidder due to the heavy loads carried. There is thus a need for a skidder having an arch assembly that is optimally position on the rear section and for a skidder with a reinforced connection between the tandem bogey and the rear frame, which does not reduce the ground clearance of the rear section.

Also, with conventional skidders with hydrostatic transmissions, the operators cannot select their gear ratios in accordance with the load carried and the ground conditions. Therefore, problems often occur when going uphill with heavy loads because the hydrostatic transmission of the skidder is usually not in the appropriate gear ratio to obtain an adequate traction. Moreover, powerful engines are required with hydrostatic transmission to carry the load on difficult ground conditions.

In conventional skidders, the front and the rear wheels of the skidder have the same ground speed ratio. Therefore, both front and rear wheels push and pull the skidder and its carried load. Tandem bogey breakages often occur because the rear section has to push and pull the skidder and simultaneously support the load. There is thus a need to reduce the stresses applied to the rear section.

Moreover, when going uphill or downhill, it frequently occurs that the front or the rear wheels of the tandem bogey are in the air and does not provide support and traction to the skidder. To improve the traction of the skidder, it would be desirable to maintain the front and the rear wheels of the tandem bogey in substantially continuous contact with the ground.

Finally, skidder transmissions often include front and rear differential locks which are actuated simultaneously with only one actuator. However, when the differential locks are actuated, the skidder cannot turn since both left and right wheels rotate at the same speed. For skidders having a tandem bogey in the rear section, when the differential locks are actuated and carrying loads, high stresses are often applied on the tandem bogey that cause tandem bogey breakage.

Finally, even with tandem bogey skidders, there is always a need for a skidder with an improved flotation that will cause less soil erosion.

### SUMMARY OF THE INVENTION

It is an object of the present invention to provide a new log skidder having a rear section with a tandem bogey which addresses the above concerns.

One aspect of the invention provides a felled tree transporter, which comprises: a front section and a rear section with a frontward portion pivotally connectable to the front section. The rear section has a frame, a tandem bogey mounted to the frame, and an arch assembly pivotally mounted to the frame at a pivot point. The tandem bogey has a central transversal axis, the pivot point being located above the tandem bogey between the central transversal axis and the frontward portion, the arch assembly being actuated by at least one arm having a first end mounted to the frame between the frontward portion and the pivot point.

Another aspect of the invention provides a skidder rear section, which comprises a frame with an articulation joint; a tandem bogey supporting the frame onto the ground and having a central transversal axis; and an arch assembly pivotally mounted to the frame at a pivot point located above the tandem bogey between the central transversal axis and the articulation joint, the arch assembly being actuated by at least one arm having a first end mounted to the frame between the articulation joint and the pivot point.

Another aspect of the invention provides a skidder rear section used for hauling logs in combination with a front section. The rear section comprises: a rear chassis pivotally connectable to the front section at a pivot axis; a tandem bogey mounted to the rear chassis and having revolving support members for supporting the rear chassis, the revolving support members being imparted a rear ground speed when actuated; and an arch assembly mounted to the rear chassis. The front section comprises: a front chassis with front wheels supporting the front chassis, the front wheels being imparted a front ground speed, when actuated, faster than the rear ground speed.

Another aspect of the invention provides a felled tree transporter, which comprises: a front section; and a rear section having a frame, a tandem bogey mounted to the frame, and an arch assembly mounted to the frame, the front section being pivotally connectable to the front section at a pivot axis, the tandem bogey having a left rear axle and a right rear axle, each driving a front wheel and a rear wheel, gear trains in driven contact with the left rear axle and the right rear axle and providing substantially equal power transmission to the front and the rear wheels, and a torque divider for each of the left and the right rear axles, the torque divider separating unequal torque on the rear and front wheels into two substantially equal torques.

Another aspect of the invention provides a forestry vehicular machine, which comprises: a front section having a front frame, an engine mounted to the front frame, and a powershift transmission operatively connected to the engine; a rear section having an arch assembly frame, a tandem bogey supporting the arch assembly frame onto the ground, and an arch assembly mounted to the arch assembly frame, the tandem bogey having a rear axle operatively connected to revolving support members, the rear section being pivotally connectable to the front section at a pivot axis; and a rearwardly extending drive shaft having a first end operatively connected to the powershift transmission of the front section and a second end operatively connected to the rear axle of the rear section, the rearwardly extending drive shaft being divided into a least two sections separated by a support member for reducing the vibrations.

Another aspect of the invention provides a method for operating a log skidder having front wheels and a tandem bogey with revolving support members. The method comprises: imparting a first ground speed to the front wheels; imparting a second ground speed to the revolving support members, slower than the first ground speed.

Another aspect of the invention provides a forestry vehicular machine, which comprises: a front section supported by two front wheels; a rear section articulately connected to the front section and having a frame supported on the ground by a tandem bogey with revolving support members and an arch assembly mounted to the frame; and an engine operatively connected to the front wheels and the revolving support members, the front wheels being imparted a front ground speed and the revolving support members being imparted a rear ground speed, when actuated by the engine, the ratio between the front and the rear ground speeds being greater than 1.

A further aspect of the invention provides a log skidder, which comprises: a front assembly having a front axle with a left section and a right section and a front differential with a front differential lock operatively connected to the front axle; and a rear assembly pivotally connectable to the front assembly at a pivot axis, the rear assembly having a frame with a tandem bogey and a boom assembly mounted to the frame, the tandem bogey having a rear axle with a left section and a right section and a rear differential having a rear differential lock operatively connected to the rear axle, the rear and the front differential locks being actuated independently of one another.

Another aspect of the invention provides a felled tree transporter, which comprises: a front section; and a rear section pivotally connectable to the front section at a pivot axis. The rear section has a frame with a longitudinal axis dividing the frame into a right side and a left side, a tandem bogey mounted to the frame, and an arch assembly mounted to the frame. The frame has two substantially vertical walls spaced from one another by a transversally extending channel. The tandem bogey has a rear axle, inserted into the transversally extending channel. The tandem bogey is mounted to the frame with at least two fastening members positioned under the rear axle in each one of the right and the left sides and connecting the two substantially vertical walls together, the at least two fastening members in one of the right and the left sides being spaced from one another.

### BRIEF DESCRIPTION OF THE DRAWINGS

Further features and advantages of the present invention will become apparent from the following detailed description, taken in combination with the appended drawings, in which:

FIG. 1 is a side elevation view of a log skidder with a front section and a rear section in accordance with an embodiment of the present invention;

FIG. 2 is a rear elevation view of the log skidder shown in FIG. 1;

FIG. 3 is a top plan view of the rear section of the log skidder shown in FIG. 1;

FIG. 4 is a schematic view of a power transmission of the log skidder in accordance with an embodiment of the present invention;

FIG. 5 is a schematic side elevation view, fragmented, of a rearwardly extending driving shaft of the log skidder shown in FIG. 1;

FIG. 6 is a top plan view of a tandem bogey of the log skidder shown in FIG. 1;

FIG. 7 is a side elevation view of the tandem bogey shown in FIG. 6, with parts shown in phantom lines;

FIG. 8 is a cross-section view, fragmented, of a torque divider used with the tandem bogey shown in FIG. 6;

FIG. 9 is a perspective view, fragmented, of the rear section of the log skidder shown in FIG. 1, wherein the tandem bogey has been removed;

FIG. 10 is a perspective view, fragmented, of the rear section shown in FIG. 9, wherein the tandem bogey is mounted to the rear section; and

FIG. 11 is a perspective view, fragmented, of the rear section shown in FIG. 9, wherein fastening members have been mounted to the rear section;

It will be noted that throughout the appended drawings, like features are identified by like reference numerals.

### DETAILED DESCRIPTION OF THE PREFERRED EMBODIMENT

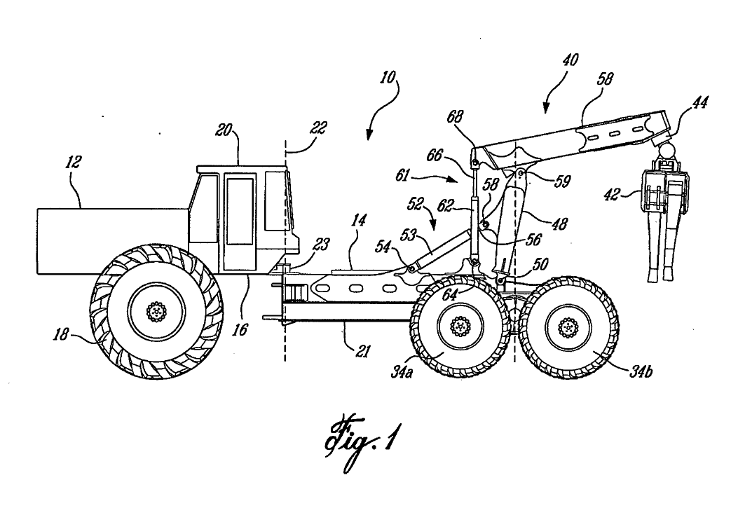

Referring to FIG. 1, a felled tree transport vehicular machine, a log skidder, is shown generally at 10. The skidder 10 includes a front section 12 and a rear section 14.

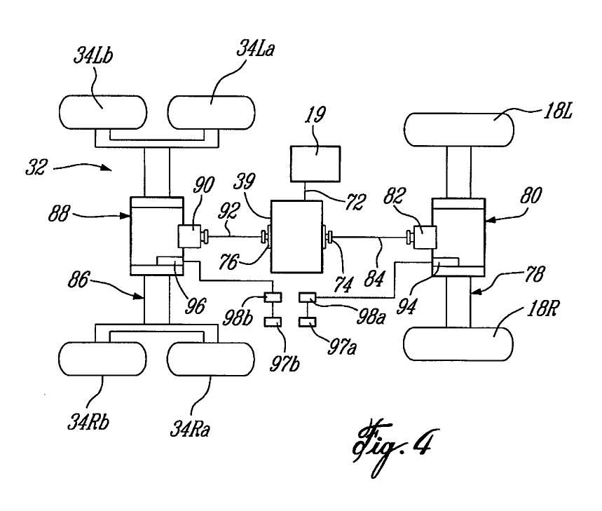

The front section 12 includes a front chassis 16, or an engine frame, supported by two front wheels 18 (18L for the left front wheel and 18R for the right front wheel), or revolving support members, with rubber tires. A conventional engine 19 (FIG. 4) and an operator's cab 20 are mounted to the front chassis 16.

The rear section 14 has a rear chassis 21, or a boom assembly frame. The rear chassis has a frontward portion which is articulately mounted to the rearward portion of the front chassis 16 in a conventional manner and pivots about pivot axis 22. Each of the front and rear chassis 16, 21 has an articulation joint 23. The articulation joints of the front and rear chassis 16, 21 are joined with two articulation pins (not shown). One skilled in the art will appreciate that other mechanisms can be used to articulately connect the front and the rear chassis 16, 21. For example, without being limitative, the front chassis 16 can include a towing hitch that is joined to a draw bar hitch of the rear section 14.

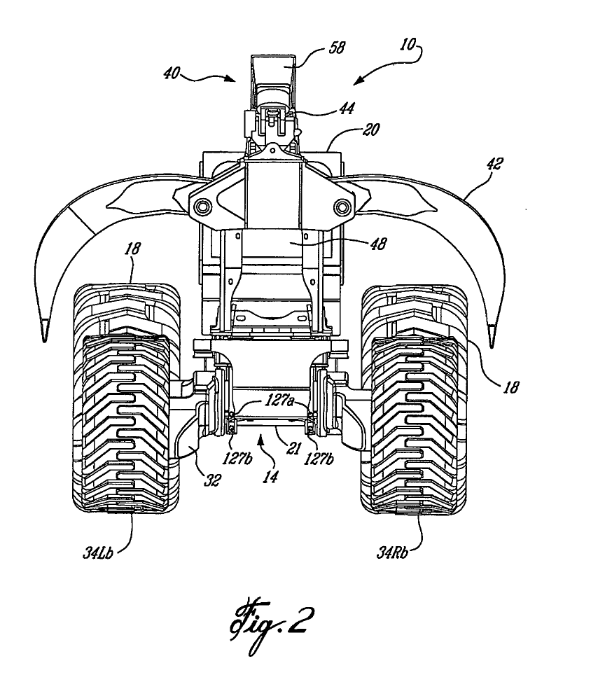

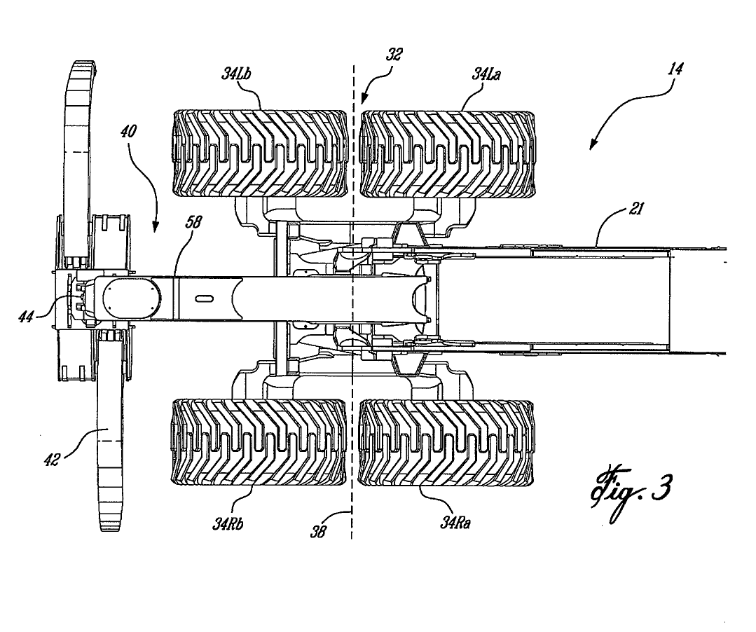

Referring simultaneously to FIGS. 1 to 3, it will be seen that the rear chassis 21 of the skidder 10 is supported by a two-axle bogey 32, or a tandem bogey or a tandem axle, having four rear wheels 34 with rubber tires, or revolving support members. As clearly shown on FIG. 2, two rear wheels 34 are disposed on each lateral side of the rear chassis 21 (34L for the left rear wheels and 34R for the right front wheels). On each lateral side, both wheels 34 are symmetrically mounted relatively to a central transversal axis 38 of the tandem bogey 32 (34a for the front wheels of the tandem bogey 32 and 34b for the rear wheels of the tandem bogey 32).

The front and rear wheels 18, 34 of the skidder 10 are driven by conventional drive trains from the engine 19 through a transmission 39 (FIG. 4) controlled by the operator. The rear wheels 34 are preferably power driven for independent traction and drive, as it will be described in more details below. Steering is accomplished by varying the angular relationship between the front and rear sections 12, 14 with a hydraulic cylinder steering valve (not shown) actuated by a steering wheel (not shown). However, any other appropriate steering mechanisms, known to the person skilled in the art, can be used.

An arch assembly 40 (or boom assembly) is pivotally mounted to the rear chassis 21 and has a conventional grapple 42, with continuous rotation, suspended from its free end 44 to grapple a bunch of felled trees. The arch assembly 40 is preferably actuated hydraulically, as it will be described in more details below.

The arch assembly 40 includes a main arch 48 which has a first end pivotally mounted to the rear chassis 21 of the rear section 14 at 50. The main arch 48 is mounted for pivotal movement between forwardmost and rearwardmost positions relatively to a vertical axis (not shown). The travel of the main arch 48 is controlled by two extendable arms 52 having a first end pivotally connected at 54 to the rear chassis 21, on a respective lateral side, in front of the pivot 50. Each extendable arm includes an hydraulic cylinder 53 and a cylinder piston 56 slidably mounted into the hydraulic cylinder 53. The cylinder pistons 56 are, in turn, pivotally connected to the main arch 48 at a position 58.

The pivot 50 of the main arch 48 is positioned above the tandem bogey 32, frontwardly of the central transversal axis 38, towards the frontward portion of the rear chassis 21. The pivot 50 is preferably positioned between the central transversal axis 38 and the frontward portion of the front wheels 34a of the tandem bogey 32. The distance between the central transversal axis 38 and the pivot 50 is preferably shorter than 60 centimeters. The tandem bogey 32 provides an important weight distribution and reduces the ground disturbance during the hauling of felled trees from a logging site. The rear section 14 is supported on a relatively wide (fore-to-aft) footprint. Positioning the pivot 50 of the main arch 48 above the tandem bogey 32, forwardly of the central transversal axis 38 allows to maintain the desired lifting force at the grapple or cable end. The log weight is transferred to the main arch 48 above the tandem bogey 32. The positioning of the pivot 50 of the arch assembly 40 reduces the tandem bogey 32 and the arch assembly 40 breakages.

A arch arm 58, or boom, is pivotally mounted to a second end of the main arch 48 at 59. The grapple 42 is articulately mounted to the free end 44 of the arch arm 58. The arm arch 48 is controlled by one or more extendable arms 61 having hydraulic cylinders 62 with a first end pivotally connected at 64 to the rear chassis 21, between the pivot 50 of the main arch 48 and the pivot 54 of the hydraulic cylinders 53. Cylinder pistons 66 are slidably mounted into the hydraulic cylinders 53. The cylinder pistons 66 are, in turn, pivotally connected to a second end 68 of the arch arm 58. The pivot point 59 of the arch arm 58 on the main arch 48 is located between the first end 60 and the second end 68 of the arch arm 58. A person skilled in the art will appreciate that other types of arch assemblies can be used.

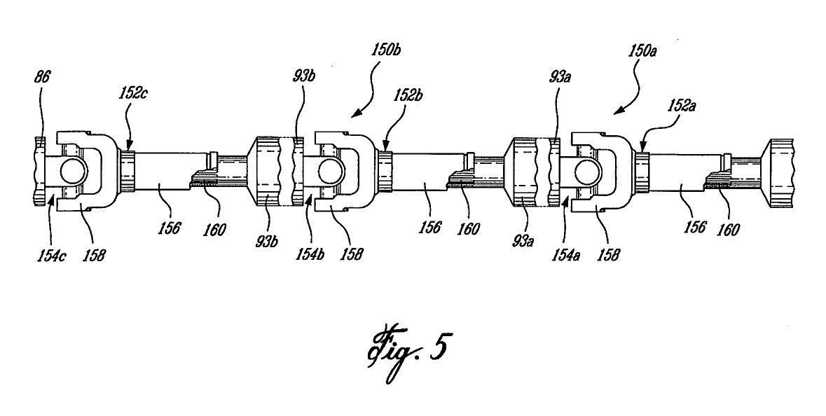

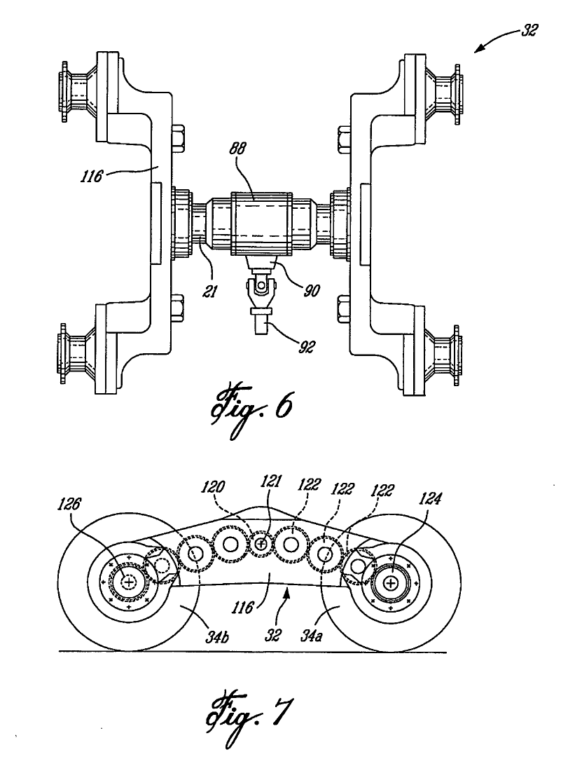

Referring to FIG. 4, it will be seen that the engine 19 is operatively connected to a transmission box 39 through a transmission driving shaft 72. The transmission box 39 has a front mechanical output 74 and a rear mechanical output 76. The front wheels 18 are mounted to a front axle 78 which is provided with a front differential 80 having a front mechanical input 82. A forwardly extending drive shaft 84 extends between the front mechanical output 74 of the transmission 39 and the front mechanical input 82 of the front axle 72. The front differential 80 divides the driving force equally between the front wheels 18 and allows one wheel 18 to rotate faster than the other wheel 18. Similarly the rear wheels 34 are mounted to a rear axle 86 having a rear differential 88 with a rear mechanical input 90. A rearwardly extending drive shaft 92, which is divided into a plurality of sections 93 (FIG. 5) as will be described in more details below, extends between the rear mechanical output 76 of the transmission 39 and the rear mechanical input 90 of the rear axle 86. Again, the rear differential 88 divides the driving force equally between the rear wheels 34 and allows one wheel 34 to rotate faster than the other wheel 34. One skilled in the art will appreciate that the driving shafts 72, 84, 92 can have one or more sections.

In one embodiment, the front and the rear differentials 80, 88 are respectively provided with a front and a rear differential locks 94, 96 that lock the left and right drive axles 78, 86 of the front and rear axles, which extend transversely from the differentials 80, 88 together so that they rotate together at the same speed and the left and right wheels 18, 34 are driven at the same speed. These differential locks 94, 96 are conventional. In one embodiment, the front differential lock 94 is actuated by pressurizing clutches (not shown). The front differential lock 94 can be actuated while operating the skidder 10. The rear differential lock 96 is collarshift and, contrary to the front differential lock 94, it cannot be actuated while operating the skidder 10. Preferably, each differential lock 94, 96 is actuated independently of the other one by any mechanisms known to one skilled in the art. For example, in FIG. 4, each differential lock 94, 96 is operatively connected to a respective electric switch 97a, 97b and a respective hydraulic switch 98a, 98b, which applies a pressure on the differential locks 94, 96 to actuate the latter. Therefore, the operator can independently actuated the electric switches 97a, 97b to respectively actuate either the front differential lock 94 or the rear differential lock 96. Therefore, it is possible to lock the left and the right sections of the front axle 78 independently of the rear axle 86 when high stresses are applied on the rear section 14 or to simultaneously turn the skidder 10.

As the skidder 10 is operated, the left front wheel 18L can encountered reduced traction conditions when compared to the right front wheel 18R. In this situation, the front differential would allow the left front wheel 18L to speed up and correspondingly reduce the speed of the right front wheel 18R. If actuated, the locked front differential 80 would keep both front wheels 18 rotating at the same speed, slowing down the left front wheel 18L and speeding up the right front wheel 18R. When actuated, the rear differential lock 96 operates in the same manner as the front differential lock 94 described above.

Actuating independently the differential locks 94, 96 of the front and the rear sections 12, 14 reduces the probabilities of tandem bogey breakage because, when the operator engages the front differential lock 94 to improve the skidder traction, the rear differential lock 96 is not automatically actuated. The skidder 10 remains maneuverable since the left rear wheels 34L can rotate at a different speed than the right rear wheels 34R to turn the skidder 10.

Preferably, the front and the rear axles 78, 86 are connected to the engine 19 through a powershift direct drive transmission 39, or direct shift gearbox, with 8 speeds forward and 8 speeds reverse, such as the D.F. transmission, model 180 commercialized by John Deere. The powershift transmission 39 allows clutch packs to engage or disengage “on the move” so the skidder 10 can continue working without decelerating during shifting. The skidder 10 having a powershift transmission has an increased power, even with a motor having less powerful motor, since the operator can select a predetermined speed. Therefore, the carrying capacity of the skidder 10 having the powershift transmission 39 is increased. One skilled in the art will however appreciate that another transmission can be used and/or the transmission can have a different number of speeds.

Implementing the powershift transmission 39 on the skidder 12 having a long wheel base (longer than 3.8 meters), i.e. the distance between the center of the front wheels 18 and the center of the tandem bogey 32, requires a long rearwardly extending driving shaft 92 to reach the rear axle 86 of the tandem bogey 32. However, long rearwardly extending driving shafts 92 transmit high vibrations, i.e. drive line vibrations, to the rear axle 86. Referring to FIG. 5, it will be seen that, to reduce the vibration transmission between the powershift transmission 39 and the rear axle 86, the rearwardly extending driving shaft 92 is divided in a plurality of sections 93. A support 150 is provided between the sections 93 of the rearwardly extending driving shafts 92. Each support 150 includes a slip yoke 152 and a universal joint connection 154. The supports 150 allow movements in the three directions and reduce the vibrations transmitted to the rear axle 86.

The slip yoke 152 has a body formed by a hollow sleeve 156. One end 158 of slip yoke 152 is U-shaped and is connected to the universal joint connection 154 with shaft section 93 or another component of the skidder 10.

The end of the sleeve 156 opposite to the U-shaped end 158 is open and received a drive shaft section 93, which drives the slip yoke 152. The sleeve 156 and the drive shaft section 93 are connected by a series of splines 160, which establish a slip joint between the sleeve 156 and the drive shaft section 93. The splines 160 transfer rotational movement from the drive shaft section 93 to the slip yoke 152 and at the same time permit the slip yoke 152 to slide axially on the drive shaft section 93.

One embodiment of the rearwardly extending driving shafts 92 is shown in FIG. 5. The rearwardly extending driving shaft 92 include: a slip yoke 152a, which connects the rear mechanical output 76 (FIG. 4) to a front universal joint 154a. The front universal joint 154a is a swivel connection that fastens the first slip yoke 152a to a first section 93a of the rearwardly extending drive shaft 92. The first section 93a of the rearwardly extending drive shaft 92 transfers turning power from the front universal joint 154a to a second slip yoke 152b. The second slip yoke 152b is connected to a second universal joint 154b. The same pattern is reproduced until the desired length of the rearwardly extending drive shaft 92 is reached. Finally, a rear slip yoke 152c connects the last section of the rearwardly extending drive shaft 92 to the rear universal joint 154c and transfers torque to the gears in the rear axle 86. A person skilled in the art will appreciate that the supports 150 can differ from the embodiment shown in FIG. 5. Moreover, the rearwardly extending drive shaft 92 can include more or less drive shaft sections 93.

For adequately reducing the vibration transmission, each drive shaft section 93 is preferably shorter than 150 centimeters.

The skidder's operator operates the powershift transmission 39 through its range of speeds by means of the rotary switch 218 mounted in the cab of the vehicle. The operator, by turning the rotating rotary switch 218, can select any one of the eight forward speeds or the eight reverse speeds.

The engine 19 respectively imparts a front ground speed to the front wheels 18 and a rear ground speed to the rear wheels 34. Preferably, the ratio of the front ground speed and the rear ground speed is higher than 1 and, more preferably, between one and 1.25. A ratio above 1 allows the skidder 10 to climb on soft grounds rather than to sink up. The traction properties of the skidder 10 are also increased. This is also advantageous when going rearward since the front section 12 pushes the rear section 14.

Moreover, when the front wheels 18 rotate faster than the rear wheels 34, it reduces the stresses applied on the tandem bogey 32 and the arch assembly 40 since the front section 12 is mostly responsible for pulling the skidder 10 when going forward and pushing the skidder 10 when going rearward. Therefore, the probabilities of breaking the arch assembly 40 and/or the tandem bogey 32 are reduced.

For achieving the ratio between the front and the rear ground speeds, the diameter of the rubber tires surrounding the front wheels 18 can be greater than the diameter of the rubber tires surrounding the rear wheels 34. For example, the front wheels 18 can have rims with a width of 35.5 inches (90.2 centimeters) and a diameter of 32 inches (81.3 centimeters). The tires surrounding the front rims can have a diameter of 79.2 inches (201.2 centimeters). The rear wheels 34 can have rims with a width of 29.5 inches (74.9 centimeters) and a diameter of 26.5 inches (67.3 centimeters). The tires surrounding the rear rims can have a diameter of 58.4 inches (148.3 centimeters). Moreover, higher rubber tires for the front wheels 18 improve the floatability of the skidder 10 on soft grounds and provides a higher ground clearance. It is also possible to adjust the gear ratio of the front wheels 18 and the rear wheels 34 to obtain a higher ground speed for the front wheels 18 than for the rear wheels 34.

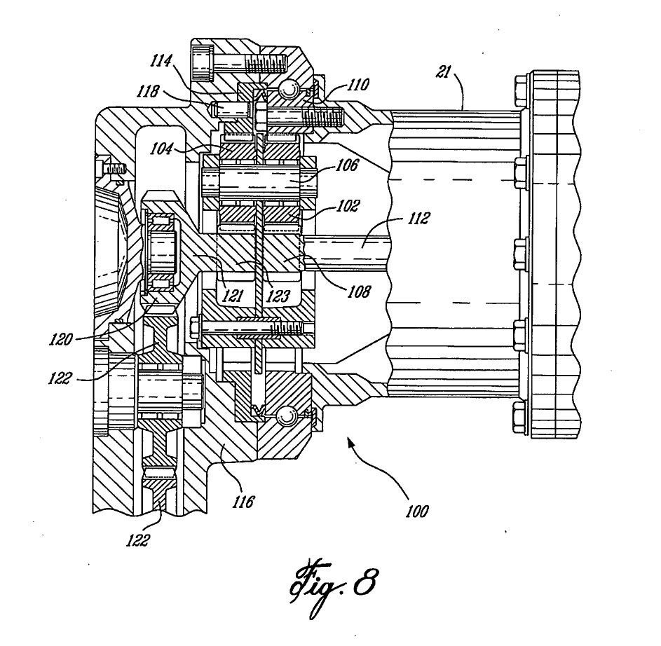

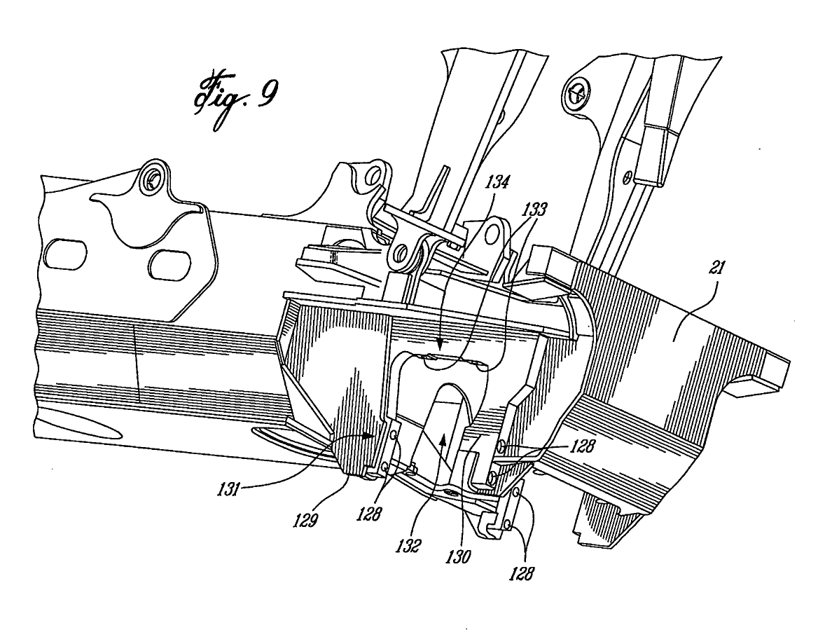

The tandem bogey 32 preferably includes torque dividers, such as the one disclosed in U.S. Pat. No. 5,417,297, which allows load stability. As mentioned above, the engine power is transferred equally to both the front and the rear wheels 34a, 34b of the tandem bogey 32. Referring to FIGS. 7 to 9, it will be seen that the tandem bogey 32 has having two torque dividers 100 (only one is shown) which split any unequal torque on the front and the rear wheels 34a, 34b into two equal torques to obviate wheel lifting and loss of traction. A first torque divider 100 is associated with the left rear wheels 34La, 34Lb and the other one is associated with the right rear wheels 34Ra, 34Rb. In an embodiment, the torque divider 100 has a first planetary gear 102 with a first planet wheel and a second planetary gear 104 with a second planet wheel. The first and the second planet wheels of the planetary gears 102, 104 are connected securely with one another on a planetary gear shaft 106. The first planet wheel of the planetary gear 102 is connected to a first sun gear wheel 108 and is best situated in an internal-geared housing part 110 so that it can be turned, where this housing part 110 is firmly screwed to the rear frame 21 and the first sun gear wheel 108 is connected to a drive shaft 112 for rotation of the first sun gear wheel 108 and the first planet wheel of the planetary gear 102. On the other hand, the second planetary gear wheel 104 is best situated so that it can be turned in an internal-geared housing part 114 which is attached to a tandem bogey housing 116 by means of a clamp 118.

In the torque divider 100, the power is transmitted from the drive shaft 112 via the first sun gear wheel 108 and the first planetary gear wheel 102 coaxially geared with it, and the in continuation, via the second planetary gear wheel 104, which is securely fastened to the first planetary gear wheel 108, to a second sun gear wheel 123. The second sun gear wheel 123 drives a central drive shaft 121, which transmits the power to a gear wheel 120. The gear wheel 120 distributes the power by means of a plurality of gear wheels 122 to two planetary end stages 124, 126.

The tandem bogey 32 including torque dividers makes it possible, if there is one-sided stress on the tandem wheels 34 of a side, for the high torque to be divided, thus producing a small, effective tandem bogey gear reduction with little lift effect. Through the feed into the tandem bogey housing, a part of the torque thus introduced into this side of the tandem bogey can be used to effectively counter the lift pressure. This means that the wheel lifting up is pushed against the ground. A slight lift, however, is not necessarily bad since it is thus possible to “climb over” an obstacle encountered on the ground, for example, a stone or a stump.

The so-called lift effect, which results from an unequal power stress on one of the two wheels 34a or 34b of the tandem axle 32, is limited by means of the torque divider 100 used so that the unequal torque produced is divided into two equal torques, which, on the one hand, work against the rear frame 21 and, on the other hand, against the tandem axle housing 116, thus providing a counterforce to the wheel 34 that is lifting.

Torque dividers in the tandem bogeys 32 allow for excellent traction in all conditions and reduced ground pressure over uneven ground. Mobility is easier on difficult terrain because of the tandem bogeys 32 distributing the weight optimally between the wheels for better traction and impact to the soil. For example, 60% of the weight can be distributed on the rear wheels of the tandem bogey 32 and the remaining 40% on the front wheels of the tandem bogey 32 when going forward. On the opposite, 60% of the weight can be distributed on the front wheels of the tandem bogey 32 and the remaining 40% on the rear wheels of the tandem bogey 32 when going rearward. Furthermore, the bogey 32 described above increases the operator's comfort by reducing the frequency of the shock transmitted to the operator.

Even if the tandem bogey 32 in the embodiment described includes torque dividers, one skilled in the art will appreciate that other tandem bogeys 32 can be used.

Referring to FIGS. 2, 10 to 12, it will be seen that the tandem bogey 32 is secured to the rear frame 21 with eight fastening members in a manner such that there is four fastening members on each lateral side of the rear chassis 21. In the embodiment shown, two fastening members 127a, 127b positioned on a respective lateral side of the rear chassis 21 are under the rear axle 86 and joined the front portion and the rear portion of the rear frame 21. The fastening members 127a, 127b are bolts simultaneously inserted into holes 128 in a front vertical wall 129 and a rear vertical wall 130, as shown in FIG. 11. The fastening members 127a, 127b and the holes 128 in which they are inserted defined a first fastening area 131.

The front and the rear vertical walls 129, 130 are separated from one another by a transversal channel 132. Two fasteners (not shown), such as bolts, are simultaneously inserted into holes 133 in the rear frame 21, above the transversal channel 131, and in the rear axle 86. The fasteners inserted into the holes 133 are above the rear axle 86 and define a second fastening area 134.

Each fastening area 131, 134 includes two fastening members. In FIG. 12, the fastening members 127a, 127b are bolts. However, one skilled in the art will appreciate that other fastening members can be used.

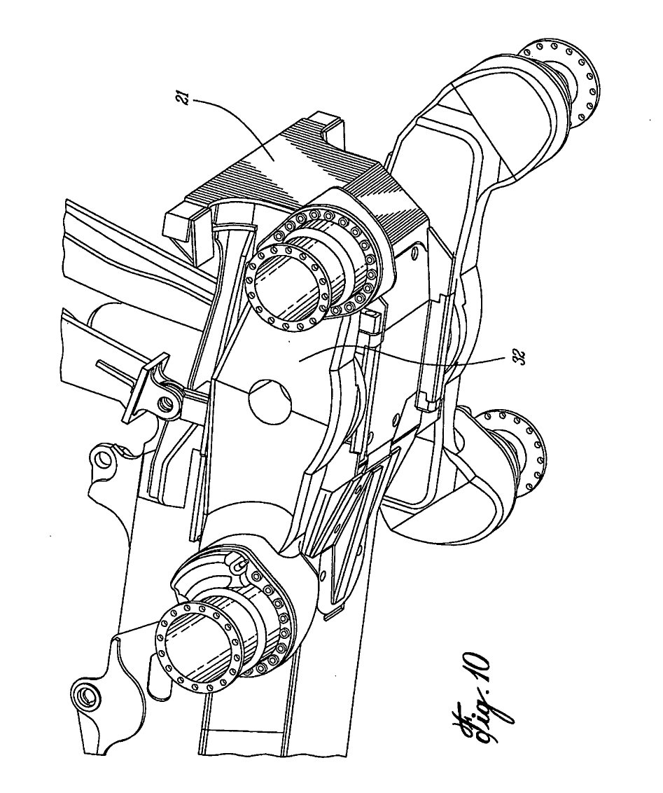

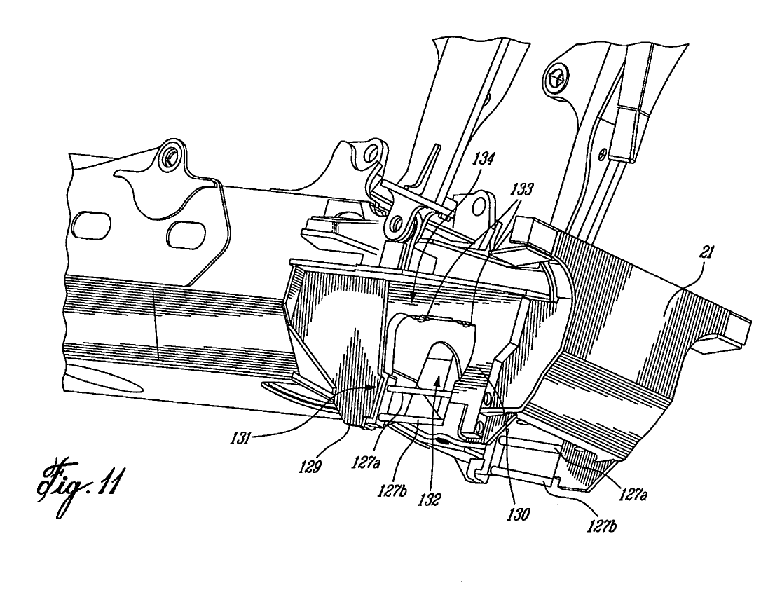

Referring to FIGS. 10 and 11, it will be seen that the rear axle 86 of the tandem bogey 32 is inserted into the transversal channel 132, above the fastening members 127a, 127b, when the tandem bogey 32 is secured to the rear frame 21. The fastening members 127a, 127b of the fastening area 131 are spaced along the vertical axis. The spacing between the two fastening members 127a, 127b preferably ranges between an abutting relationship and 15 centimeters. For the first fastening area 131, the two fastening members 127a, 127b, spaced from one another and linking the front vertical wall 129 and a rear vertical wall 130 of the rear frame 21, substantially reinforce the link between the tandem bogey 32 and the rear frame 21.

The two fastening members 127a, 127b in the first fastening area 131 increase the pressure applied to maintain the tandem bogey 32 and the rear frame 21 assembled. This prevents the tandem bogey 32 from flipping when carrying a normal load. This is done without reducing the ground clearance of the skidder 10 in the rear section 14.

The fastening members 127a, 127b for the first fastening area 131 are preferably oriented substantially horizontally while the fastening members for the second fastening area 134 are preferably oriented substantially vertically.

The tandem bogey 32 thus secured to the rear frame 21 can support higher stresses without breaking or flipping. A person skilled in the art that any one of the fastening areas 131, 134 can include more than two fastening members to increase the strength of the connection between the tandem bogey 32 and the rear frame 21.

Since the skidder 10 is reinforced and more powerful, the wheel base of the skidder 10, i.e. the spacing between the front wheels 18 and the rear wheels 34, can be longer than with conventional skidders for an improved flotation, stability, and front traction. The wheel base is preferably ranging between 208 inches (5.28 meters) and 220 inches (5.6 meters). This wheel base also allows an improved traction when going uphill with the skidder 10. The tandem bogey 32 and the position of the arch assembly on the rear section 21, amongst others, permits the increase of the wheel base. The wheel base can thus be increased without weakening the skidder 10.

The skidder 10 allows an increased ground protection while maintaining a good maneuverability on uneven grounds. Moreover, higher capacity grapples can be used with the skidder 10 rather than with conventional skidders.

The disruption of and damage to the forest floor, soil and undergrowth are considerably reduced because the skidder 10 has a longer wheel base and a tandem bogey 32 in the rear section 14. To reduce the tandem bogey 32 and the arch assembly 40 breakages, the pivot 50 of the arch assembly 40 has been positioned above the tandem bogey 32, frontwardly of its center. To improve the power of the skidder 10 for carrying loads without increasing the vibration transmission, a powershift transmission 39 with supports in the rearwardly extending drive shaft 92 has been implemented. To improve the flotation of the front section 12 and reduce the rear section breakages, a ground speed ratio between the front and the rear wheels 18, 34 higher than 1 has been implemented. To ensure a continuous ground contact for the front and the rear wheels of the tandem bogey 32, torque dividers have been mounted to the tandem bogey 32 for separating unequal torque on the wheels into two substantially equal torques. Independently actuated differential locks 94, 96 have been mounted to the front and rear axles 78, 86. Therefore, the operator can engage the front differential lock 94 to improve the skidder traction without actuating the rear differential lock 96. The skidder 10 remains maneuverable since the left rear wheels 34L can rotate at a different speed than the right rear wheels 34R to turn the skidder 10. This reduces the probabilities of tandem bogey breakage. Finally, the connection between the rear frame 21 and the tandem bogey 32 has been reinforced without reducing the ground clearance of the rear section 14.

The embodiments of the invention described above are intended to be exemplary only. For example, it is appreciated that an endless track belt can encircle both wheels 34 on a lateral side of the tandem bogey 32 and rotate with the wheels 34. It is also appreciated that the grasping element of the skidder 10 can be either a grapple or a cable. The scope of the invention is therefore intended to be limited solely by the scope of the appended claims.

What is claimed is:

1. A forestry vehicular machine, comprising:
a front section supported by two front wheels;
a rear section articulately connected to the front section and having a frame supported on the ground by a tandem bogey with revolving support members and an arch assembly mounted to the frame; and
an engine operatively connected to the front wheels and the revolving support members, the front wheels being imparted a front ground speed and the revolving support members being imparted a rear ground speed, when actuated by the engine, the ratio between the front and the rear ground speeds being greater than 1.

2. A forestry vehicular machine as claimed in claim 1, wherein the ratio between the front and the rear ground speeds ranges between 1 and 1.25.

3. A forestry vehicular machine as claimed in claim 1, wherein the diameter of the front wheels is greater than the diameter of the revolving support members.

4. A forestry vehicular machine as claimed in claim 1, wherein the engine and the front wheels are operatively connected through front gears and the engine and the revolving support members are operatively connected through rear gears, the front and the rear gears defining a gear ratio allowing to obtain the ratio between the front and the rear ground speeds.

5. A forestry vehicular machine as claimed in claim 1, wherein the front section and the rear section are pivotally connected at a pivot axis, the tandem bogey has a central transversal axis and the arch assembly is pivotally mounted to the frame at a pivot point located above the tandem bogey between the central transversal axis and the pivot axis.

6. A method for operating a log skidder having front wheels and a tandem bogey with revolving support members, comprising:
imparting a first ground speed to the front wheels;
imparting a second ground speed to the revolving support members, slower than the first ground speed.

7. A skidder rear section used for hauling logs in combination with a front section, the rear section comprising:
a rear chassis pivotally connectable to the front section at a pivot axis;
a tandem bogey mounted to the rear chassis and having revolving support members for supporting the rear chassis, the revolving support members being imparted a rear ground speed when actuated; and
an arch assembly mounted to the rear chassis;
the front section comprising:
a front chassis with front wheels supporting the front chassis, the front wheels being imparted a front ground speed, when actuated, faster than the rear ground speed.

8. A combination as claimed in claim 7, wherein the ratio between the front ground speed and the rear ground speed ranges between 1 and 1.25.

9. A combination as claimed in claim 7, wherein the diameter of the front wheels is greater than the diameter of the revolving support members.

10. A combination as claimed in claim 7, comprising an engine operatively connected to the front wheels through front gears and operatively connected to the revolving support members through rear gears, the front and the rear gears defining a gear ratio allowing to obtain the ratio between the front and the rear ground speeds.

11. A log skidder, comprising:
a front assembly having a front axle with a left section and a right section and a front differential with a front differential lock operatively connected to the front axle; and
a rear assembly pivotally connectable to the front assembly at a pivot axis, the rear assembly having a frame with a tandem bogey and a boom assembly mounted thereto, the tandem bogey having a rear axle with a left section and a right section and a rear differential having a rear differential lock operatively connected to the rear axle, the rear and the front differential locks being actuated independently of one another.

12. A log skidder as claimed in claim 11, comprising a front differential lock actuator operatively connected to the front differential lock and a rear differential lock actuator operatively connected to the rear differential lock.

13. A log skidder as claimed in claim 12, wherein at least one of the front differential lock actuator and the rear differential lock actuator comprises an electric switch.

14. A log skidder as claimed in claim 11, wherein the boom assembly is pivotally mounted to the frame at a pivot point located above the tandem bogey between the rear axle and the pivot axis.

15. A log skidder as claimed in claim 11, wherein the front differential lock is an hydraulic differential lock and the rear differential lock is collarshift.

16. A felled tree transporter, comprising
a front section; and
a rear section pivotally connectable to the front section at a pivot axis, the rear section having a frame with a longitudinal axis dividing the frame into a right side and a left side, a tandem bogey mounted to the frame, and an arch assembly mounted to the frame, the frame having two substantially vertical walls spaced from one another by a transversally extending channel, the tandem bogey having a rear axle, inserted into the transversally extending channel, the tandem bogey being mounted to the frame with at least two fastening members positioned under the rear axle in each one of the right and the left sides and connecting the two substantially vertical walls together, the at least two fastening members in one of the right and the left sides being spaced from one another.

17. A felled tree transporter as claimed in claim 16, wherein the at least two fastening members are spaced from one another along a vertical axis.

18. A felled tree transporter as claimed in claim 16, wherein the at least two fastening members are oriented substantially horizontally.

19. A felled tree transporter as claimed in claim 16, wherein the arch assembly is pivotally mounted to the frame at a pivot point located above the tandem bogey between the rear axle and the pivot axis.

20. A felled tree transporter as claimed in claim 19, wherein the arch assembly is actuated by at least one arm having a first end mounted to the frame between the pivot axis and the pivot point.

21. A felled tree transporter as claimed in claim 19, wherein the distance between the at least two fastening members range between 5 and 15 centimeters.
